(19) United States
(12) Patent Application Publication
(10) Pub. No.: US 2008/0073141 A1
(43) Pub. Date: Mar. 27, 2008

(54) Occupant Protection System and Method

(76) Inventor: Jose Rafael Rafael Jaunarena-Ferrari, Guaynabo, PR (US)

Correspondence Address: CARLA FERRARI-LUGO LAW OFFICE, PO BOX 988, AGUADILLA, PR, 00605, US

(21) Appl. No.: 11/534,810

(22) Filed: Sep. 25, 2006

(51) Int. Cl. B60R 21/00; B60Q 1/00

(52) U.S. Cl. 180/268; 340/457.1; 280/801.1

(57) ABSTRACT

An occupant protection system is disclosed for indicating when a passenger is occupying a seat. The system alerts the driver of the fact that a passenger is in the passenger's seat through visual and/or audio indicia, which will be activated when the passenger's seatbelt is buckled. A timing circuit, which will be activated a predetermined time after the car seat is locked, will generate the audio and/or visual indicia which will be deactivated when the driver's seatbelt is buckled, ensuring both passenger and driver's safety. Once the driver's seatbelt is unbuckled, the system will detect that the passenger seatbelt is buckled and will generate the audio and/or visual indicia to indicate that the passenger, particularly a child and/or baby is in the car.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The present invention relates to an occupant protection system and method. Particularly, the present invention relates to a protection system to detect and/or alert people that an occupant is present in a transportation means.

### BACKGROUND OF THE INVENTION

Occupant's safety is a mayor concern, particularly when dealing with people who are otherwise unable to take care of themselves such as disabled/elderly people, babies and/or children. There have been a number of accidents resulting in death involving situations wherein adults have forgotten that they are traveling with babies and/or small children and are left inside the automobile. The majority of the accidents related to children's death, after having been unintentionally left on the automobile, have occurred because people are taken out of their daily routine. Often time tragedies like this happen because a responsibility that is typically carried out by a parent and/or attendant is delegated to the other parent and/or attendant. This is especially relevant in the society we live now, where both parents have to work to sustain a family and where everything is done in a hurry. Routine can and has in fact resulted in tragedies. Because it doesn't seam that this lifestyle will change, individuals may find it desirable or even necessary to benefit from this invention.

There have been prior attempts in the art to solve the abovementioned problems. However, they all fail to solve the problem in an efficient and economical way. Thus, there is a need for an occupant protection system to detect the presence of a passenger in any type of traveling apparatus, but particularly in child restraining seats.

### SUMMARY OF THE INVENTION

The present invention solves the aforementioned problems by providing an occupant protection system that produces a visual and/or audible indicia to remind parents and/or attendants not to leave their baby and/or child behind or unattended. With this occupant protection system caretakers will be alerted so that no more lives are lost due to babies and/or children being left behind and/or locked inside vehicles.

To achieve the foregoing and other advantages, the present invention, briefly described, provides an occupant protection system comprising an alarm indicia wherein the sensor equipped rear and front seatbelts are selectively linked. When the car seat's seatbelt is locked into its base, which in turn is connected to the rear seatbelt, the alarm is activated after a predetermined period of time. When the driver buckles the driver's seatbelt the visual and/or audible indication comes to a halt. However, the systems works so that when the driver unbuckles to exit the vehicle, the audible and/or visual indication is activated again as a reminder to take the baby and/or child along.

Advantageously, in accordance with the present invention, the occupant protection system is designed so as to ensure safety for both the driver and the passenger. This is achieved because when the car seat is locked into its base the alarm is activated, and it will continue to alert the driver until the time the driver buckles up. By producing an audio and/or visual indicia up and until the time the driver buckles up, this invention furthers safety for both the driver and the passenger.

In another aspect of the invention, the system comprises a timing circuit selectively connected to the passenger detection device and the driver's detection device so that when the car seat buckle sensor is locked, the visual and/or audible indication will be actuated after a predetermined time. Said predetermined time could be any from cero to 50 seconds preferably 30 seconds. Once the predetermined time has lapsed, the visual and/or audible indication will be actuated up and until the driver's detection device is actuated.

In accordance with another embodiment of the invention, the occupant protection system is designed so that the seatbelt buckle sensor comprises at least one of magnetic sensor, ultrasound sensor, proximity sensor, capacitive sensor, infrared sensor, RF sensor, mechanical sensor, solid-state sensor, electromechanical sensor, pressure sensor, contact sensor, biometric sensor or any combination thereof.

Advantageously, in accordance with the present invention, the occupant protection system comprises a disable/override switch selectively connected to at least one of the system's components so that it can be manually deactivated.

In still another aspect of the invention, the occupant protection device can be removed in relation to the passenger seatbelt buckle and the driver seatbelt buckle. Accordingly, this system is designed so that it can be selectively adapted to other transportation means such as a stroller, motorcycle, ground vehicle, ATV, marine vehicle, aircraft, or any combination thereof, with the advantage that it is portable, removable and adaptable to any of the above referenced transportation means.

Numerous objects, features and advantages of the present embodiment of the invention will be readily apparent to those of ordinary skill in the art upon a reading of the following detailed description of presently preferred, but nonetheless illustrative, embodiments of the invention when taken in conjunction with the accompanying drawings. In this respect, it is to be understood that the embodiment of the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present embodiment of the invention.

### BRIEF DESCRIPTION OF THE DRAWINGS

The preferred embodiments of the invention will hereinafter be described in conjunction with the included drawings provided to illustrate and not to limit the invention, wherein like designations denote like elements, and in which:

FIG. 1 shows a perspective view of the invention.

FIG. 2 shows a side view of the preferred embodiment of the invention.

FIG. 3 shows a perspective view of an alternative embodiment of the invention.

FIG. 4 shows a block diagram of the preferred embodiment of the invention.

### DETAILED DESCRIPTION OF THE INVENTION

This specification and the accompanying figures disclose the preferred embodiment as example of the invention. The drawings illustrated in the figures are not to scale and are only intended to serve as illustrating examples of the invention. The invention is not intended to be limited to the embodiment illustrated. Numerous modifications, changes, variations, substitutions and equivalents will be apparent to those skilled in the art without departing from the spirit and scope of the present invention.

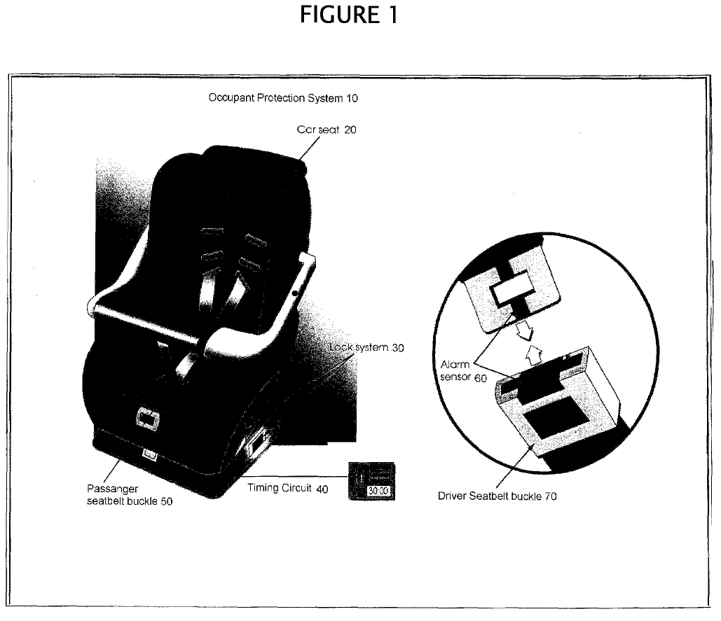

Referring now to FIG. 1 the occupant protection system 10 is shown with car seat 20 locked into the car seat lock system 30, wherein the timing circuit 40 is located.

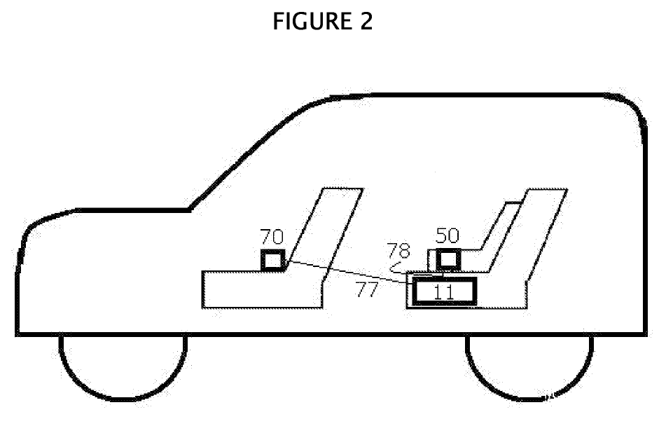

Referring now to FIG. 2 the passenger detection device, which in a preferred embodiment comprises a seatbelt buckle 50. Preferably, the seatbelt buckle 50 further comprises a sensor 60 integrally formed with the seatbelt buckle. However, as will be explained later, it is also desirable to provide a removable sensor 60, selectively adapted to form part of a removable/portable occupant protection system. In one aspect of the invention, the sensor 60 comprises at least on of: magnetic sensor, ultrasound sensor, proximity sensor, capacitive sensor, infrared sensor, RF sensor, mechanical sensor, solid-state sensor, electromechanical sensor, pressure sensor, contact sensor, biometric sensor or any combination thereof.

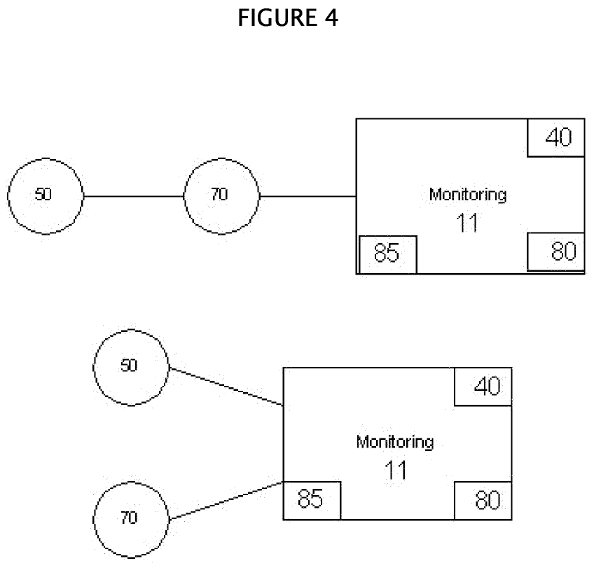

In a preferred embodiment of the invention, a monitoring device 11 is selectively connected to the passenger detection device and to the driver detection device. The monitoring device could be selected from the group comprising at least one of a microprocessor, logical circuit, software implementation, a hardwired circuit or a combination thereof. According to one aspect of the invention, the passenger detection device and the driver detection device can be either serially connected in relation to said monitoring device 11 or individually connected in relation to said monitoring device by cables 77 and 78 as shown in FIG. 2 and FIG. 4. It should be understood that the selected connection arrangement would be at least in part based on: the type of power and/or data signal, any spatial/distance considerations, and the type of circuit used to implement the system. In a preferred embodiment of the invention, the passenger detection device comprises the car seat buckle 50, and the driver detection device comprises the driver's seatbelt buckle 70.

According to one aspect of the invention, the passenger detection device and the driver detection device are integrally formed with a passenger seatbelt buckle 50 and a driver seatbelt buckle 70 respectively so that it is part of the seatbelt buckle.

Further in another embodiment of the invention, the passenger detection device and the driver detection device are selectively removable in relation to a passenger seatbelt buckle 50 and a driver seatbelt buckle 70 so that the system is removable and capable of being installed at least in one of: a stroller, infant carrier, motorcycle, bicycle, marine vehicle, ATV, ground vehicle, aircraft or any transportation means. Because the present invention in at least one of its embodiments is capable of being removably connected to the system, as used herein the term driver refers not only to a vehicle driver, but a person that causes a transportation means to travel, such as a person that is driving a stroller, a cyclist and the like.

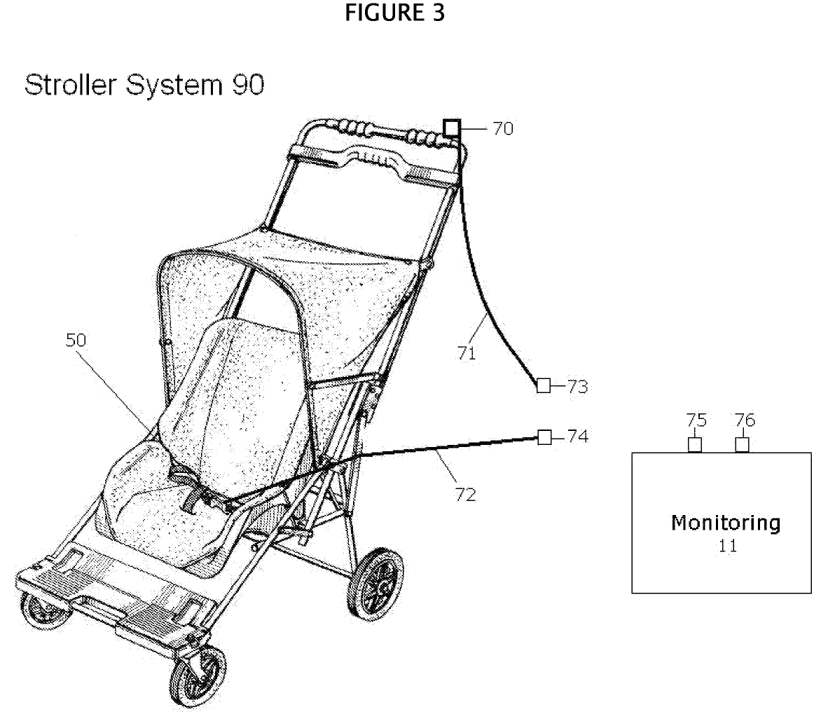

In this embodiment, a single occupant protection system is adapted to be selectively shared among a plurality of transportation means. For example, the system could be removably installed in a vehicle while driving to a shopping mall. After the vehicle is parked at the shopping mall, a driver uninstalls the system from the vehicle and proceeds to install it in an infant stroller 90 that will be used while shopping in the mall as shown in FIG. 3. Once the driver finishes shopping and returns to the vehicle, the system is uninstalled from the infant stroller 90 and re-installed in the vehicle as shown in FIG. 2. Alternatively, only the monitoring/indicating devices are adapted to be selectively shared among a plurality of transportation means. In this embodiment, a plurality of interchangeable passenger detection devices 70 and a plurality of interchangeable driver detection devices 50 are also provided to selectively interface with the abovementioned monitoring/indicating devices through a set of cables 72/78 and 71/77, respectively as shown in FIG. 3 and FIG. 2. For example, a set of driver/passenger detection devices are removably installed in the vehicle, while another set of driver/passenger detection devices are removably installed in the stroller, wherein a user only needs to selectively connect the monitoring/indicating devices with each set of detecting devices when transferring the system from one transportation means to another. A standard and uniform connector/mating arrangement 73/76 and 74/75 could be used so that different types of detecting devices are used and connected/mated with a single monitoring device as shown in FIG. 3.

In another aspect of the invention, the monitoring device 11 outputs an indicating signal to the indicating device 80 when a monitored conditioned occurs. In a preferred embodiment the monitoring device 11 and the indicating device 80 are integrally adapted into a single unit. Alternatively, both devices could be formed separately and interfaced appropriately. Additionally, in the preferred embodiment, said indicating device 80 comprises at least one of: a sound alarm, a flashing light, a vehicle alarm, a LED, a vehicle horn, a vehicle speaker system, a voice message, or a combination thereof. However, it is also envisioned that any visual and/or audio indicia could be selectively used in order to alert the driver that an occupant is present in the passenger seat, which in a preferred embodiment is a car seat 20. Moreover, said indicating signal could be outputted to a location remote from the transportation means. In an alternate embodiment, said indicating signal is wirelessly transmitted to at least one of: a carry-on device, a central monitoring station, a signal repeating infrastructure arrangement, a law enforcement station, a stolen vehicle monitoring station (LoJack/OnStar), a pager, a cellphone, a blackberry device, a PDA, or any combination thereof.

According to one aspect of the invention, the connections among the passenger detection device, the driver detection device, the monitoring device and the indicating device could be through a wired connection, a wireless connection, or any combination thereof. Preferably, the wireless connection is selected from at least one of: a RF connection, an IR connection, WIFI connection, Bluetooth connection, an ultrasound connection, or any combination thereof. Moreover, the wire connection could be a single wire carrying at least one of: data and power signals over the same wire or a plurality of wires carrying at least one of data and power signals.

The system further comprises a source of power 85 which could be selected from at least one of: a lighter power adapter, a solar power means, a removable energy storage means, a rechargeable energy storage means, a vehicle electrical system connection or any combination thereof.

While a preferred embodiment of the occupant protection system has been described in detail, it should be apparent that modifications and variations thereto are possible, all of which fall within the true spirit and scope of the invention. While in the preferred embodiment, a monitored condition comprises the situation when the driver unbuckles his/her seatbelt and a child's seatbelt remains buckled with a child seated, it is also possible to monitor a different condition. For example, in the case where the system is installed in a stroller, a desired condition to monitor would be when a driver is pushing said stroller and a child unbuckles his/her seatbelt creating a safety issue. It is therefore envisioned that a mode selection switch could also be provided to selectively enable the system to monitor a desired condition among a plurality of possible monitoring conditions.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention.

Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to, falling within the scope of the embodiment of the invention.

What is claimed is:

1. An occupant protection system comprising:
at least one passenger detection device;
at least one driver detection device;
a monitoring device connected to at least one of: said at least one driver detection device and said at least one passenger detection device; and
at least one indicating device connected to at least one of: said at least one passenger detection device, said at least one driver detection device, and said monitoring device.

2. The system of claim 1, wherein said at least one passenger detecting device and said at least one driver detecting device comprise a seatbelt buckle sensor.

3. The system of claim 1, wherein said at least one passenger detecting device and said at least one driver detecting device are serially connected in relation to said monitoring device.

4. The system of claim 1, wherein said at least one passenger detecting device and said at least one driver detecting device are individually connected in relation to said monitoring device.

5. The system of claim 1, further comprising a timing circuit electrically connected to at least one of: said at least one passenger detection device, said at least one driver detection device, said monitoring device, or any combination thereof.

6. The system of claim 2, wherein said at least one passenger detecting device and said at least one driver detecting device are integrally formed with a passenger seatbelt buckle and a driver seatbelt buckle, respectively.

7. The system of claim 2, wherein said at least one passenger detecting device and said at least one driver detecting device are selectively removable in relation to a passenger seatbelt buckle and a driver seatbelt buckle, respectively.

8. The system of claim 1, further comprising: a switch selectively connected to at least one of: said monitoring device, said indicating device, said at least one passenger detection device, said at least one driver detection device, or any combination thereof.

9. The system of claim 5, wherein said timing circuit is selectively configured to actuate said indicating device after a predetermined amount of time.

10. The system of claim 1, wherein at least one of: said at least one passenger detection device, said at least one driver detection device, said monitoring device and said indicating device are portable and selectively configured to be removed from a vehicle.

11. The system of claim 1, wherein said occupant protection system is selectively located in at least one of: a stroller, an infant carrier, a motorcycle, a bicycle, an ATV, a ground vehicle, a marine vehicle, an aircraft, or any combination thereof.

12. The system of claim 2, wherein said seatbelt buckle sensor further comprises at least one of: a magnetic sensor, an ultrasound sensor, a proximity sensor, a capacitive sensor, an infrared sensor, a pressure sensor, a contact sensor, a RF sensor, a mechanical sensor, a solid-state sensor, an electromechanical sensor, a biometric sensor, or any combination thereof.

13. The system of claim 1, further comprising at least one of: a vehicle lighter adapting connection, a solar power means, a removable energy storage means, a rechargeable energy storage means, a vehicle electrical system connection, or any combination thereof.

14. The system of claim 1, wherein the connections among the at least one passenger detection device, the at least one driver detection device, the monitoring device and the indicating device comprise at least one of: a wired connection, a wireless connection, or any combination thereof.

15. A portable warning apparatus comprising the system of claim 1, further comprising: a plurality of interchangeable passenger detection devices; a plurality of interchangeable driver detection devices, wherein at least one of said plurality of interchangeable passenger detection devices and at least one of said plurality of interchangeable driver detection devices are selectively removably connected to at least one of: said monitoring device, said at least one indicating device, or any combination thereof.

16. A method for protecting an occupant comprising:
detecting a lock/unlock state of a passenger's seatbelt;
detecting a lock/unlock state of a driver's seatbelt;
generating an indicating signal based on at least one of: the passenger's seatbelt state and the driver's seatbelt state.

17. The method of claim 16, wherein said indicating signal is generated by at least one of:
a passenger's seatbelt unlocked state and a driver's seatbelt unlocked state;
a passenger's seatbelt unlocked state and a driver's seatbelt locked state;
a passenger's seatbelt locked state and a driver's seatbelt unlocked state; and
a passenger's seatbelt locked state and a driver's seatbelt locked state.

18. The method of claim 16, further comprising:
generating at least one of: a visual indication and an audible indication, when said passenger's seatbelt is in a locked state and said driver's seatbelt is in an unlocked state.

19. The method of claim 18, wherein said at least one of: a visual indication and an audible indication, is interrupted when at least one of: said passenger's seatbelt is in an unlocked state and said driver's seatbelt is in a locked state.

20. The method of claim 16, further comprising:
selectively delaying the generation of said indicating signal for a predetermined amount of time.

21. The method of claim 18, further comprising:
manually interrupting said at least one of: a visual indication and an audible indication.

22. The method of claim 1, wherein said passenger's seatbelt is at least part of at least one of: a vehicle seat integrated child seat and a portable/removable child seat.

23. A method for protecting an occupant comprising: installing in a first transportation means at least one driver detecting device; at least one passenger detecting device; a monitoring device and an indicating device; and generating an indication signal when a monitored condition occurs in said first transportation means.

24. The method of claim 23, further comprising selecting a desired condition to be monitored from a plurality of different conditions.

25. The method of claim 23, further comprising selecting said at least one driver detecting device from a plurality of interchangeable driver detecting devices; and selecting said at least one passenger detecting device from a plurality of interchangeable passenger detecting devices.

26. The method of claim 23, further comprising uninstalling from said first transportation means at least one of: said at least one driver detecting device; said at least one passenger detecting device; said monitoring device and said indicating device; and installing said at least one uninstalled device in a second transportation means to monitor a condition at said second transportation means.

27. The method of claim 26, wherein said monitored condition in the second transportation means is different from the monitored condition in the first transportation means.
